(19) United States
(12) Patent Application Publication
(10) Pub. No.: US 2013/0106689 A1
(43) Pub. Date: May 2, 2013

(54) METHODS OF OPERATING SYSTEMS HAVING OPTICAL INPUT DEVICES

(71) Applicant: Kenneth Edward Salsman, Pleasanton, CA (US)

(72) Inventor: Kenneth Edward Salsman, Pleasanton, CA (US)

(21) Appl. No.: 13/660,911

(22) Filed: Oct. 25, 2012

Related U.S. Application Data
(60) Provisional application No. 61/551,356, filed on Oct. 25, 2011.

(51) Int. Cl. G06F 3/00

(52) U.S. Cl. CPC G06F 3/005
USPC 345/156

(57) ABSTRACT

A system may be provided that includes computing equipment and an optical input accessory. The computing equipment may use an imaging system to track the relative locations of light sources on the optical input device and to continuously capture images of optical markers on the optical input accessory and of user input objects. The computing equipment may be used to operate the system in operational modes that allow a user to record and playback musical sounds based on user input gathered with the optical input device, to generate musical sounds based on user input gathered with the optical input device and based on musical data received from a remote location, to provide musical instruction to a user of the optical input device, to generate a musical score using the optical input device, or to generate user instrument acoustic profiles.

This application claims the benefit of provisional patent application No. 61/551,356, filed Oct. 25, 2011, which is hereby incorporated by reference herein in its entirety.

### BACKGROUND

This relates generally to systems that gather user input and, more particularly, to systems with optical input devices for gathering user input. Electronic devices often have input-output components. For example, an electronic device may contain an output component such as a display or status indicator light for providing visual output to a user or may have a speaker or buzzer for providing audible output to a user. Input components such as electrical switches may be used to form keyboards, dedicated buttons, and other electromechanical input devices.

It may be desirable in some electronic devices to use other types of input devices. For example, it may be desirable to use optical input devices that can accept input in ways that would be difficult or impossible using electromechanical input devices based on switches.

### BRIEF DESCRIPTION OF THE DRAWINGS

FIG. 1 is a diagram of an illustrative system of the type that may include an optical input device in accordance with an embodiment of the present invention.

FIG. 2 is a perspective view of an illustrative optical input device in accordance with an embodiment of the present invention.

FIG. 3 is a diagram of illustrative light intensity modulations that can be used to generate intensity-modulated light that is specific to a given light source in accordance with an embodiment of the present invention.

FIG. 4 is diagram showing how virtual characters on a system display may be controlled based on captured images of user actions with respect to one or more optical input devices in accordance with an embodiment of the present invention.

FIG. 5 is a diagram of illustrative instrument sound profiles generated by a system of the type shown in FIG. 1 showing how the intensity profile of sound generated by an instrument may vary depending on the type of instrument and the type of action used to play the instrument in accordance with an embodiment of the present invention.

FIG. 6 is a flow chart of illustrative steps that may be used in recording and playing backing musical sounds based on user input gathered with an optical input device in accordance with an embodiment of the present invention.

FIG. 7 is a flow chart of illustrative steps that may be used in generating musical sounds based on user input gathered with an optical input device and musical data received from a remote location in accordance with an embodiment of the present invention.

FIG. 8 is a flow chart of illustrative steps that may be used in providing musical instruction to a user of an optical input device in accordance with an embodiment of the present invention.

FIG. 9 is a flow chart of illustrative steps that may be used in generating a musical score using an optical input device in accordance with an embodiment of the present invention.

FIG. 10 is a flow chart of illustrative steps that may be used in generating user instrument acoustic profiles for a system having an optical input device in accordance with an embodiment of the present invention.

FIG. 11 is a block diagram of a processor system employing the embodiment of FIG. 1 in accordance with an embodiment of the present invention.

### DETAILED DESCRIPTION

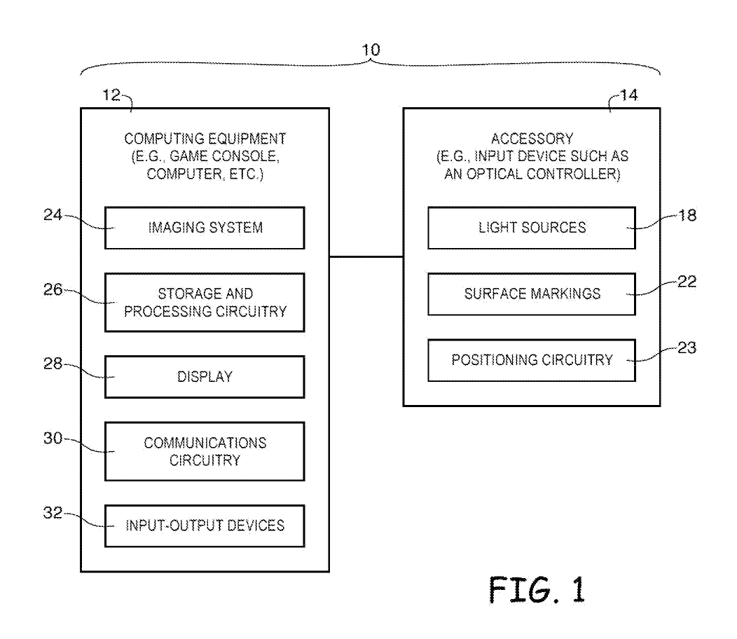

An illustrative system in which an optical input device may be used is shown in FIG. 1. As shown in FIG. 1, system 10 may include an optical input device (optical controller) such as accessory 14. Accessory 14 may, for example, be a game controller such as a poly-instrument that includes one or more musical instruments such as a keyboard, a guitar, drums, etc.

Accessory 14 may optionally be connected to external electronic equipment 12 such as a computer or game console. Accessory 14 may, for example, be coupled to equipment 12 using communications path 16. Path 16 may be a wireless path or a wired path (e.g., a Universal Serial Bus path). However, this is merely illustrative. If desired, input from accessory 14 may be provided to equipment 12 using images of accessory 14 captured using, for example, imaging system 24 of equipment 12.

Input such as user input from accessory 14 may be used to control equipment 12. For example, user input from accessory 14 may allow a user to play a game on computing equipment 12 or may allow a user to supply information to other applications (e.g., a music creation application, etc.).

Optical input device 14 may contain one or more light sources 18 and visually recognizable markings such as optical markers 22 (e.g., painted, drawn, printed, molded or other optical markers such as images of plano keys, guitar strings, drum pads, gaming control buttons or other visual representations of user input structures). If desired, device 14 may include positioning circuitry 23 such as one or more accelerometers. Light sources 18 may be lasers, light-emitting diodes or other light sources that emit light that is later detected by a light sensing component such as imaging system 24 of computing equipment 12.

A user of system 10 may supply input to system 10 using optical input device 14 by moving a finger or other object with respect to optical markers 22. For example, a user may strike an image of a plano key on a surface of accessory 14 with a given velocity and impulse. Imaging system 24 may capture high-speed, high-resolution images of the user motion with respect to the markers. Control circuitry such as storage and processing circuitry 26 may be used to extract user input data from the images of the user motions and the optical markers. The user input data may include motion data, velocity data, and impulse data that has been extracted from the captured images. Circuitry 26 may be used to store acoustic profiles for one or more instruments. Circuitry 26 may be used to match a stored acoustic profile for a particular instrument to optical markers in captures images and to the velocity and impulse of the user motion based on the motion data, velocity data, and impulse data. Storage and processing circuitry 26 may include a microprocessor, application-specific integrated circuits, memory circuits and other storage, etc.

Equipment 12 may include input-output devices 32 such as a speaker, light sources, a light-emitting diode or other status indicator, etc. Equipment 12 may include a display such as display 28. Display 28 may be an integral portion of equipment 12 (e.g., an integrated liquid crystal display, plasma display or an integrated display based on other display technologies) or may be a separate monitor that is coupled to equipment 12.

Display 28 and/or input-output devices 32 may be operated by circuitry 26 based on user input obtained from accessory 14. For example, display 28 may be used to display a character that mimics user actions that are performed while holding accessory 14. Equipment 12 may include communications circuitry 30 (e.g., wireless local area network circuitry, cellular network communications circuitry, etc). Communications circuitry 30 may be used to allow user input gathered using accessory 14 to be transmitted to other users in other locations and/or to allow other user input from other users in other locations to be combined with user input from accessory 14 using circuitry 26. For example, multiple users in remote locations, each having a poly-instrument such as accessory 14, may be able to play a song together using combined input from each poly-instrument.

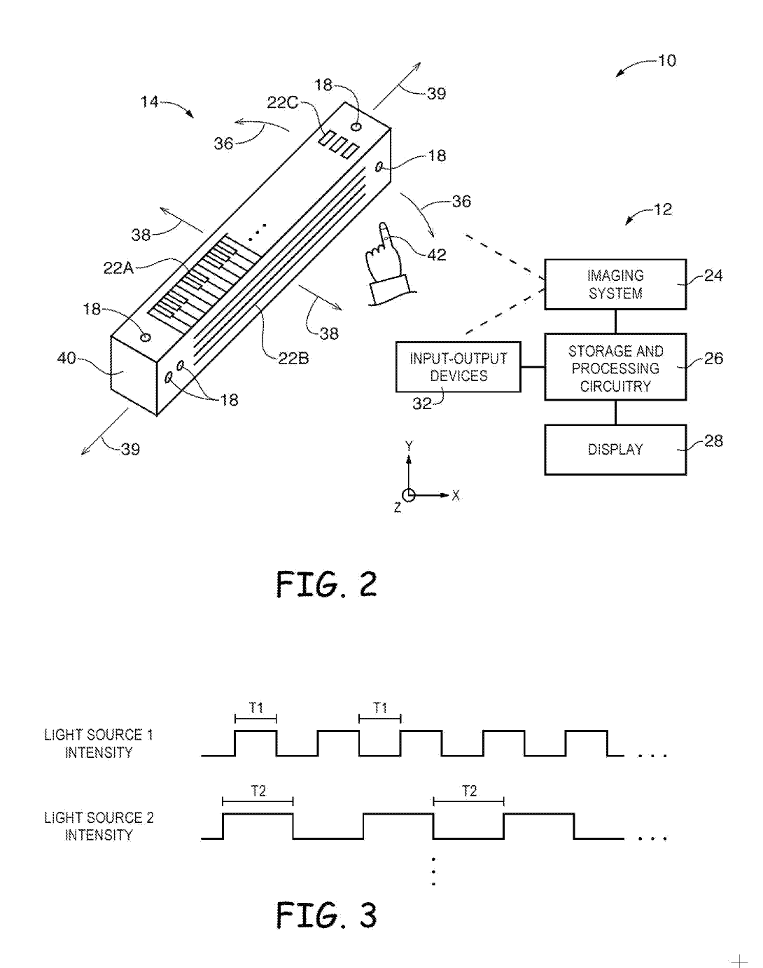

An illustrative configuration that may be used for optical input device 14 is shown in FIG. 2. As shown in FIG. 2, optical input device 14 may include a housing structure such as housing 40, optical markers 22 on housing 40 and light sources 18 mounted on housing 40. In the example of FIG. 2, accessory 14 has a rectilinear shape. However, this is merely illustrative. Other shapes and sizes of may be used for optical input device 14, if desired.

As shown in FIG. 2, accessory 14 may be implemented as poly-instrument having optical markers 22 that indicate input components for multiple instruments. Optical markers 22 may include optical markers 22A resembling plano keys (e.g., visual representations of plano keys), optical markers 22B resembling guitar strings (e.g., visual representations of guitar strings), or other instrument related optical markers (e.g., visual representations of drum pads, saxophone keys, trumpet keys, clarinet keys, or other instrument components). Optical markers 22 may also include other input key markers such as optical markers 22C that are visual representations of buttons such as power buttons, volume buttons, or other buttons for operating computing equipment 12.

Optical markers 22 may be painted, drawn, printed, molded or otherwise formed on housing 40. If desired, optical markers 22 may be formed on moving members mounted in housing 40 to give a user of accessory 14 the physical sensation of operating a button, an instrument key, instrument string or other component that is commonly formed on a moving part.

Imaging system 24 may be used to capture images of a poly-instrument such as accessory 14 of FIG. 2 during operation of system 10. Imaging system 24 may include one or more image sensors each having one or more arrays of image pixels such as complementary metal oxide semiconductor (CMOS) image pixels or other image pixels for capturing images. Imaging system 24 may be used to capture images of poly-instrument 14 and a user input device 42 such as a user's finger. Images of user input device 42 and optical markers 22 may be provided to storage and processing circuitry 26. Circuitry 26 may generate user input data based on the provided images.

User input data may be generated by determining positions of user input devices such as device 42 with respect to optical markers 22 in each image and determining motions of the user input devices based on changes in the positions of the user input devices from image to image.

For example, as a user moves their fingers against markers 22A in a plano playing motion, the positions of each finger will change with respect to markers 22A from image to image. Based on these changes, circuitry 26 may generate user input data and instruct display 28 and input-output devices 32 to take suitable action based on the user input data (e.g., to play plano sounds and display video content in accordance with the motions of the user). Circuitry 26 may use images of the users fingers and the optical markers to determine the speed and impulse with which the user moves with respect to the optical markers and generate musical sounds at a time and intensity that depends on the determined speed and impulse.

Light sources 18 may be used to emit light that is received by imaging system 24. Light sources 18 may be visible light sources and/or infrared light sources. Imaging system 24 may gather position and orientation data related to the position and orientation of accessory 14 using the captured light from light sources 18. Imaging system 24 may capture images of light sources 18 using an image sensor that is also used to capture images of optical markers 22 and user input devices 42 or imaging system 24 may include additional light sensors such as infrared light sensors that respond to and track light from light sources 18.

Imaging system 24 and circuitry 26 may be used to determine the position and orientation of accessory 14 using light from light sources 18. User input may be generated by moving accessory 14. For example, a user may move accessory 14 back and forth as indicated by arrows 39 or as indicated by arrows 38, a user may rotate accessory 14 as indicated by arrows 36 or a user may twist, turn, rotate or otherwise move accessory 14 in the x, y or z directions of FIG. 2. Imaging system 24 may track these or other types of motions by tracking the relative positions of light sources 18.

Circuitry 26 may generate user input data that is used to operate system 10 based on the tracked positions of light sources 18. For example, circuitry 26 may raise or lower the volume of music generated by devices 32 in response to detecting rotational motion of the type indicated by arrows 36. Circuitry 26 may add effects such as reverberations or pitch variations in response to detecting back and forth motion of the type indicated by arrows 38 and/or 39. Circuitry 26 may generate a first type of effect when accessory 14 is moved in a first direction and a second, different type of effect when accessory 14 is moved in second, different direction such as an orthogonal direction.

Each light source 18 may emit a type of light that is particular to that light source. Imaging system 24 and circuitry 26 may identify a particular light source 18 by identifying the particular type of light associated with that light source and determining the relative positions of the identified light sources. Imaging system 24 and circuitry 26 may generate position and orientation data that represents the position and orientation of accessory 14 using the determined positions of light sources 18.

Light sources 18 may each emit a particular frequency of light or may emit light that is modulated at a particular modulation frequency that is different from that of other light sources 18 as shown in FIG. 3. In the example of FIG. 3, a first light source may be modulated so that the intensity of that light source is high for a time T1 and transitions to low for an additional time T1 while a second light source is modulated so that the intensity of that light source is high for a time T2 and transitions to low for an additional time T2. Other light sources may be modulated from high to low for different amounts of time. Each light source may be identified by computing equipment 12 by identifying the modulating signature of that light source. However, this is merely illustrative. If desired, light sources 18 on accessory 14 may be identified based on the color of light emitted by that light source or using other properties of the light emitted by that light source.

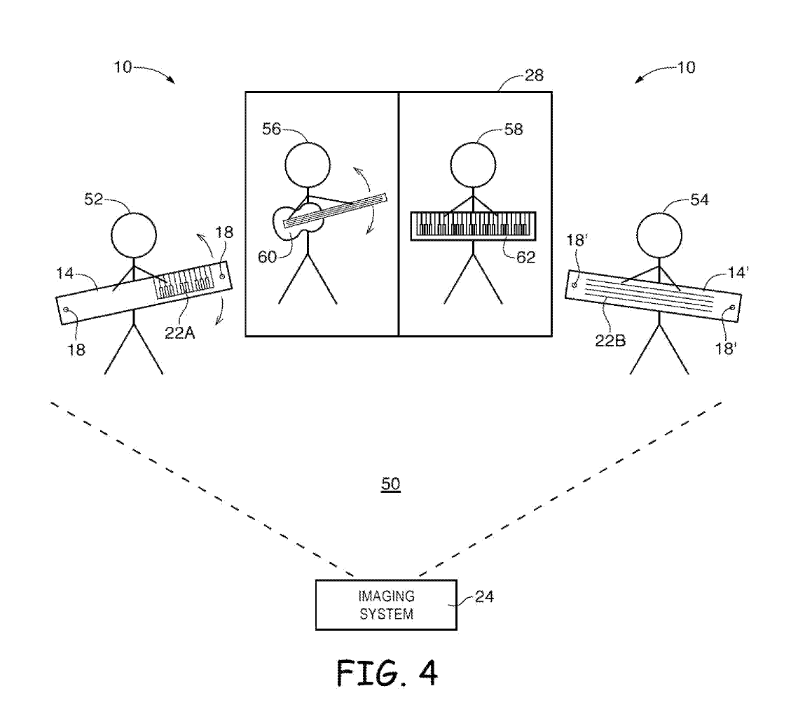

FIG. 4 is a diagram showing how one or more users may use one or more accessories 14 to operate system 10. Imaging system 24 may capture images of a field-of-view 50 that includes one or more poly-instruments such accessory 14 and accessory 14′. A first user such as user 52 may hold accessory 14 so that a first set of light sources 18 is visible to imaging system 24. Light from light sources 18 may be used to identify the type of instrument (e.g., a plano keyboard) to be used by user 52 and to identify the current position of accessory 14. System 10 (e.g., circuitry 26, not shown) may be used to generate a virtual character 58 on display 28 holding a plano keyboard 62 (or sitting at a plano) in a position that corresponds to the orientation of accessory 14. A second user such as user 54 may hold accessory 14′ so that a second set of light sources 18′ is visible to imaging system 24. Light from light sources 18′ may used to identify the type of instrument (e.g., an electric or acoustic guitar) to be used by user 54 and to identify the current position of accessory 14′. System 10 (e.g., circuitry 26, not shown) may be used to generate a virtual character 56 on display 28 holding a guitar 60 in a position that corresponds to the orientation of accessory 14′.

During operation of system 10, virtual characters 56 and 58 may move and play instruments 60 and 62 in response to captured images of user motions with respect to markers 22A and 22B and accessory motions tracked using light sources 18 and 18′. In the example of FIG. 4, two users at a common location control system 10 and two corresponding virtual users are displayed on display 28. However, this is merely illustrative. Any number of users using any number of accessories at any number of locations may cooperatively control system 10 using respective accessories.

Circuitry 26 (not shown) may receive musical data from a user at a remote location and instruct input-output devices such as a speaker to play musical sounds based on that musical data. Circuitry 26 may play the musical sounds that are based on the received musical data while generating musical sounds based on images of a user of accessory 14 or before or after generating musical sounds based on images of a user of accessory 14. In this way system 10 may be used to collaboratively play a song with a remote user, collaboratively compose music with a remote user, or competitively try to outperform a remote user.

In situations in which circuitry 26 plays the musical sounds that are based on the received musical data while generating musical sounds based on images of a user of accessory 14, circuitry 26 may modify the musical sounds that are based on the received musical data using the motion data, velocity data, and impulse data extracted from images of accessory 14 and user input device 42. For example, if a user of accessory 14 plays a song more slowly than a remote user, circuitry 26 may detect the difference between the speed of play of the remote user and the user of accessory 14 and slow the playback of the received musical data to match the speed of play of the user of accessory 14.

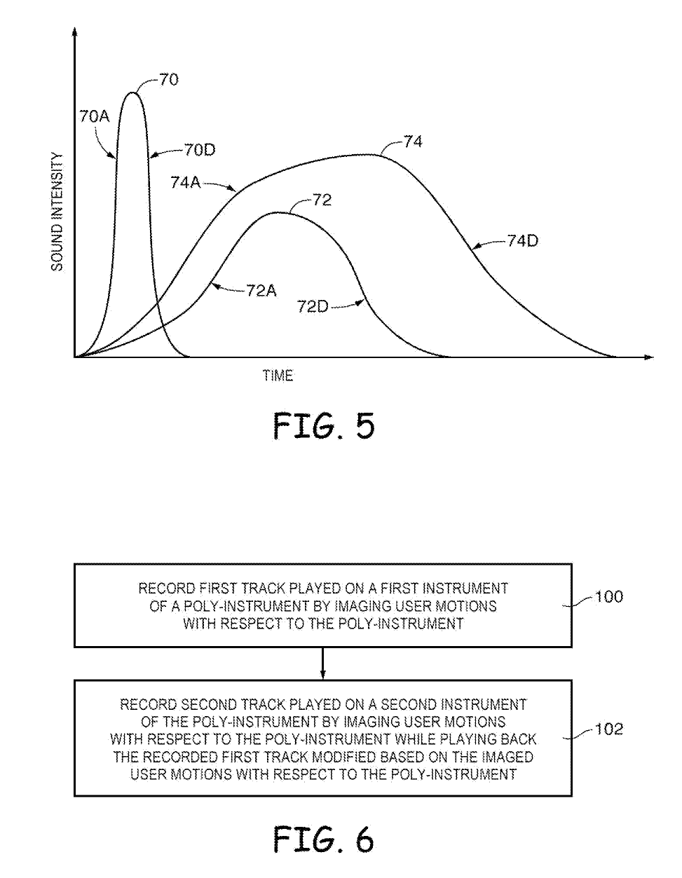

FIG. 5 is a diagram of acoustic profiles that may be stored in system 10 (e.g., using storage and processing circuitry 26 of FIG. 1). Acoustic profiles such as profiles 70, 72, and 74 may correspond to particular instruments, to particular notes played by a particular instrument, to a particular note played by a particular instrument with a particular impulse, etc. As shown in FIG. 5, each profile may include information associated with the rate at which sound from a particular instrument increases (e.g., an attack profile) and decreases (e.g., a decay profile) with time for a given impulse. As examples, acoustic profile 70 may include an attack profile 70A and a decay profile 70D for a first instrument (e.g., a drum), acoustic profile 72 may include an attack profile 72A and a decay profile 72D for a second instrument (e.g., a plano) in which the plano key is struck with a particular impulse, and acoustic profile 74 may include an attack profile 74A and a decay profile 74D for the second instrument (e.g., the plano) when the plano key is struck with a different impulse.

Instrument acoustic profiles such as profiles 70, 72, and 74 may be stored as a lookup table of musical note timing and frequency relationships that allow system 10 to generate a more realistic reproduction of an actual instruments sounds. Each profile may include an instrument's frequency profile in addition to the attack and decay profiles of FIG. 5. Motion data, velocity data, and impulse data that has been extracted from images of accessory 14 and user input device(s) 42 may be matched to entries in the lookup table that correspond to the pressure and timing with which a user interacts with optical markers 22 to produce the sounds of the desired instrument with the desired attack and decay profiles, note length and rhythm sync.

If desired, a user of system 10 may be provided with the ability to edit or modify stored acoustic profiles and/or to generate new acoustic profiles to generate new instruments for a poly-instrument such as device 14.

Computing equipment 12 may use imaging system 24 to capture images of accessory 14 and user input devices (and, if desired, light sources 18) and to operate system 10 based on those captured images in operational modes that allow a user to record and playback musical sounds based on user input gathered with an optical input device, to generate musical sounds based on user input gathered with an optical input device and based on musical data received from a remote location, to provide musical instruction to a user of an optical input device, to generate a musical score using an optical input device, or to generate user instrument acoustic profiles for a system having an optical input device (as examples).

Illustrative steps that may be used in operating a system such as system 10 having accessories such as optical input devices 14 in these operational modes (based on the captured images of the optical input device) are shown in FIGS. 6, 7, 8, 9, and 10.

Illustrative steps that may be used in operating system 10 by recording and playing backing musical sounds based on user input gathered with an optical input device are shown in FIG. 6.

At step 100, computing equipment 12 and poly-instrument 14 may be used to record a first musical track played on a first instrument of the poly-instrument by imaging user motions with respect to the poly-instrument (i.e., with respect to optical markers on the poly-instrument).

At step 102, computing equipment 12 and poly-instrument 14 may be used to record a second musical track played on a second instrument of the poly-instrument by imaging user motions with respect to the poly-instrument while playing back the recorded first track. Playing back the recorded first track may include playing back a modified version of the recorded track that is modified based on the imaged user motions with respect to the poly-instrument. Playing back a modified version of the recorded track that is modified based on the imaged user motions with respect to the poly-instrument may include slowing or speeding the rate at which the recorded track is played back based on a rate of play determined using the imaged user motions with respect to the poly-instrument.

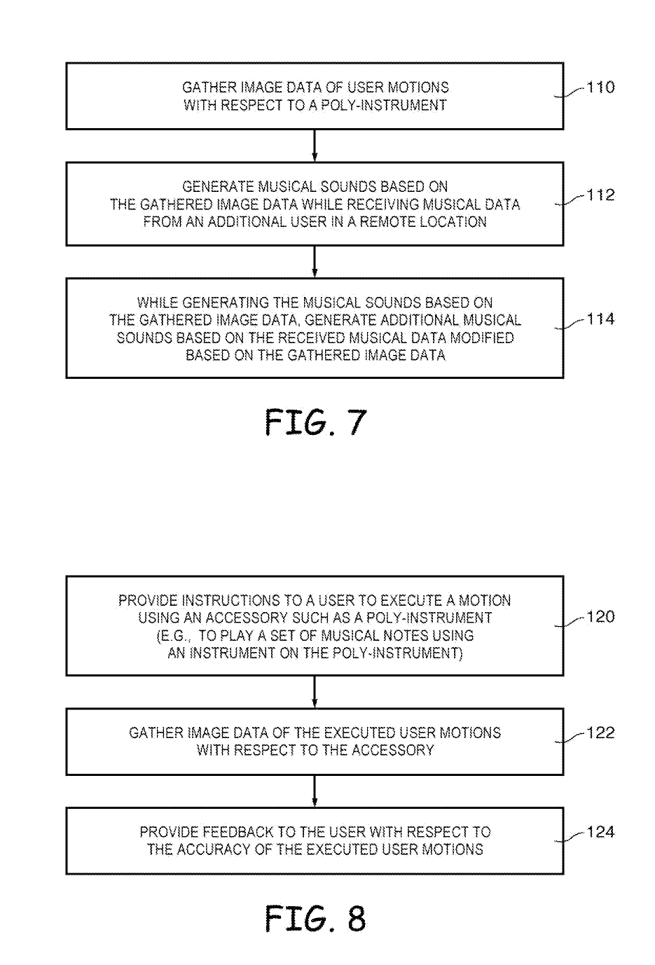

Illustrative steps that may be used in operating system 10 by generating musical sounds based on user input gathered with an optical input device and based on musical data received from a remote location are shown in FIG. 7.

At step 110, image data associated with user motions with respect to a poly-instrument such as accessory 14 may be gathered (e.g., using imaging system 24).

At step 112, musical sounds may be generated (e.g., using circuitry 26 and input-output devices 32) based on the gathered image data while musical data from an additional user at an additional location is received (e.g., using communications circuitry 30).

At step 114, while generating the musical sounds based on the gathered image data, additional musical sounds based on the received musical data, modified based on the gathered image data, may be generated. Generating the musical sounds based on the received musical data, modified based on the gathered image data, may include playing a recorded musical track from the additional user at a rate that is modified based on the rate at which the user of accessory 14 plays an additional musical track. The rate at which the user of accessory 14 plays the additional musical track may be determined based on the image data associated with the user motions.

Illustrative steps that may be used in operating system 10 by providing musical instruction to a user of an optical input device are shown in FIG. 8.

At step 120, instructions may be provided to a user of a poly-instrument such as accessory 14 to execute a motion using the poly-instrument. For example, the user may be instructed to play a set of musical notes using a particular instrument on the poly-instrument. The user may be instructed to play a set of written musical notes or to mimic a performance of a set of musical notes that has been played using audio or video equipment of system 10. Display 28 and/or input-output devices 32 may be used to provide the instructions to the user.

At step 122, images (image data) may be gathered of the executed user motions with respect to the accessory.

At step 124, feedback may be provided to the user with respect to the accuracy of the executed user motions. For example, the user may be provided with an accuracy score based on the accuracy with which the user executed the instructed motions, a user may be presented with a playback of musical sounds generated in response to the executed motions, a virtual or real instructor may provide feedback on the accuracy of the executed motions, or other feedback may be provided to the user. Display 28 and/or input-output devices 32 may be used to provide the feedback to the user.

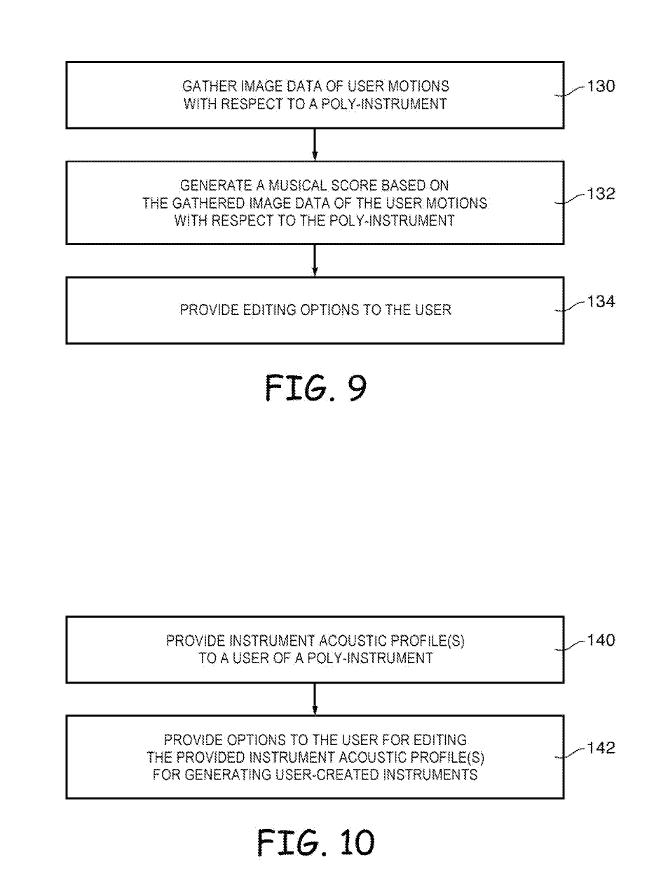

Illustrative steps that may be used in operating system 10 by generating a musical score using an optical input device are shown in FIG. 9.

At step 130, images (image data) of user motions with respect to a poly-instrument such as accessory 14 may be gathered (e.g., using imaging system 24).

At step 132, a musical score may be generated based on the gathered image data of the user motions with respect to the poly-instrument.

At step 134, the user may be provided with options for editing the generated musical score. Options for editing the musical score may include re-generating the musical score using additional image data or directly editing the musical score (e.g., using a mouse or a keyboard associated with input-output devices 32). Display 28 and/or input-output devices 32 may be used to provide the editing options to the user.

Illustrative steps that may be used in operating system 10 by generating user instrument acoustic profiles for a system having an optical input device are shown in FIG. 10.

At step 140, one or more instrument acoustic profiles may be provided to a user of a poly-instrument such as accessory 14. Display 28 and/or input-output devices 32 may be used to provide the instrument acoustic profiles to the user. Providing the instrument acoustic profiles may include presenting a graphical representation of stored acoustic profiles (e.g., the intensity vs. time curves of FIG. 5) to the user or presenting audio samples of the stored instrument acoustic profiles (as examples).

At step 142, the user may be provided with options for editing the provided instrument acoustic profiles for generating user-created instruments for the poly-instrument. Options for editing the provided instrument acoustic profiles may include providing the user with the ability to drag a graphical representation of a stored acoustic profile into a new shape or a new position or may include other options for graphically or otherwise editing the provided instrument acoustic profiles. Display 28 and/or input-output devices 32 may be used to provide the editing options to the user.

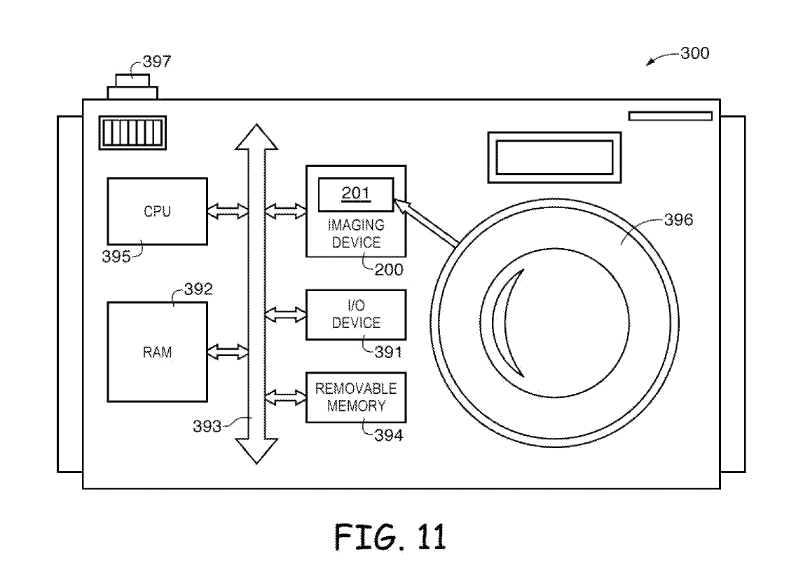

FIG. 11 shows, in simplified form, a typical processor system 300, such as computing equipment 10 of FIG. 1. Processor system 300 is exemplary of a system having digital circuits that could include imaging device 200 (e.g., an image sensor or other light sensor in imaging system 24). Without being limiting, such a system could include a computer system, still or video camera system, scanner, machine vision, vehicle navigation, video phone, surveillance system, auto focus system, star tracker system, motion detection system, image stabilization system, video gaming system, video overlay system, and other systems employing an imaging device.

Processor system 300, which may be a digital still or video camera system, may include a lens such as lens 396 for focusing an image onto a pixel array such as pixel array 201 when shutter release button 397 is pressed. Processor system 300 may include a central processing unit such as central processing unit (CPU) 395. CPU 395 may be a microprocessor that controls camera functions and one or more image flow functions and communicates with one or more input/output (I/O) devices 391 over a bus such as bus 393. Imaging device 200 may also communicate with CPU 395 over bus 393. System 300 may include random access memory (RAM) 392 and removable memory 394. Removable memory 394 may include flash memory that communicates with CPU 395 over bus 393. Imaging device 200 may be combined with CPU 395, with or without memory storage, on a single integrated circuit or on a different chip. Although bus 393 is illustrated as a single bus, it may be one or more buses or bridges or other communication paths used to interconnect the system components.

Various embodiments have been described illustrating methods for operating a system having computing equipment and an optical input accessory. The computing equipment may include an imaging system, storage and processing circuitry, a display, communications circuitry, and input-output devices such as keyboards and speakers. The optical input accessory may be an optical controller such as a poly-instrument having optical markers representing input components such as instrument components for multiple instruments. A poly-instrument may include optical markers corresponding to plano keys, drum pads, guitar strings, or other instrument components. The optical input accessory may include one or more light sources and, if desired, positioning circuitry (e.g., one or more accelerometers).

The computing equipment may track the relative locations of the light sources and continuously capture images of a user input component such as a user's finger and of the optical markers. The computing system may generate audio, video or other output based on monitoring images of the motion of the user input object with respect to the optical markers on the accessory.

The computing system may use imaging system 24 to capture images of the optical input device and user input device and may operate system 10 in operational modes that allow a user to record and playback musical sounds based on user input gathered with an optical input device, to generate musical sounds based on user input gathered with an optical input device and based on musical data received from a remote location, to provide musical instruction to a user of an optical input device, to generate a musical score using an optical input device, or to generate user instrument acoustic profiles for a system having an optical input device (as examples).

The foregoing is merely illustrative of the principles of this invention which can be practiced in other embodiments.

What is claimed is:

1. A method of operating a system having an imaging system, control circuitry, and an optical input accessory a that includes a plurality of optical markers, the method comprising:
with the imaging system, capturing images of the optical markers on the optical input accessory; and
with the control circuitry, operating the system based on the captured images of the optical markers.

2. The method defined in claim 1 wherein operating the system based on the captured images of the optical markers comprises:
recording a musical track based on the captured images of the optical markers on the optical input accessory.

3. The method defined in claim 2, further comprising:
capturing additional images of the optical markers on the optical input accessory; and
recording an additional musical track based on additional captured images of the optical markers on the optical input accessory.

4. The method defined in claim 3, further comprising:
while recording the additional musical track based on additional captured images of the optical markers on the optical input accessory, playing back the musical track that was recorded based on the captured images of the optical markers on the optical input accessory.

5. The method defined in claim 4, further comprising:
modifying the musical track that was recorded based on the captured images using the additional captured images.

6. The method defined in claim 1 wherein the system further comprises a speaker and wherein capturing the images of the optical markers on the optical input accessory comprises gathering image data associated with motions of a user with respect to the optical input device, the method further comprising:
with the speaker, generating musical sounds based on the gathered image data; and
receiving musical data from an additional user at a remote location.

7. The method defined in claim 6, further comprising:
generating additional musical sounds based on the received musical data.

8. The method defined in claim 7 wherein generating the additional musical sounds based on the received musical data comprises:
modifying the received musical data based on the gathered image data; and
generating the additional musical sounds based on the modified received musical data.

9. The method defined in claim 1 wherein the system further comprises a display, the method further comprising:
with the display, before capturing the images of the optical markers on the optical input accessory, providing instructions to a user of the optical input device to execute a motion using the optical input device.

10. The method defined in claim 9 wherein capturing the images of the optical markers on the optical input accessory comprises gathering images of the executed user motion.

11. The method defined in claim 10, further comprising:
providing feedback to the user with respect to the executed user motion.

12. The method defined in claim 1 wherein capturing the images of the optical markers on the optical input accessory comprises gathering image data associated with motions of a user with respect to the optical input device, the method further comprising:
generating a musical score based on the gathered image data.

13. The method defined in claim 12 wherein the system further comprises a display, the method further comprising:
with the display, providing options for editing the generated musical score to the user.

14. A method of operating a system that includes an imaging system, storage and processing circuitry, input-output components, and an optical input device having a plurality of optical markers that represent instrument components of an instrument, the method comprising:
with the imaging system, capturing images of the optical markers on the optical input device;
with the storage and processing circuitry, generating input data based on user motions in the images of the optical markers;
with the storage and processing circuitry, selecting, based on the input data, one of a plurality of instrument acoustic profiles for the instrument that are stored in the storage and processing circuitry; and
with the input-output components, generating musical sounds using the selected instrument acoustic profile.

15. The method defined in claim 14 wherein selecting the one of the plurality of instrument acoustic profiles for the instrument based on the input data comprises selecting an acoustic profile corresponding to a plano based on the input data.

16. The method defined in claim 15 wherein selecting the acoustic profile corresponding to the plano based on the input data comprises selecting an acoustic profile corresponding to an impulse on a plano key.

17. The method defined in claim 16 wherein the system further comprises a display, the method further comprising:
with the display, providing options to a user for editing at least some of the instrument acoustic profiles that are stored in the storage and processing circuitry.

18. A system, comprising:
a central processing unit;
memory;
input-output circuitry;
an imaging device; and
an optical input accessory, comprising optical markers on a surface of the optical input accessory, wherein the central processing unit is configured to play a recorded musical track that is stored in the memory while using the imaging device to capture images of the optical markers on the surface of the optical input device.

19. The system defined in claim 18, wherein the central processing unit is further configured to modify the recorded musical track based on the captured images of the optical markers on the surface of the optical input device.

20. The system defined in claim 19 wherein the imaging device comprises an array of image pixels.
